(19) United States
(12) Patent Application Publication
(10) Pub. No.: US 2021/0243602 A1
(43) Pub. Date: Aug. 5, 2021

(54) UAV SERVICE SUPPORTING METHOD AND DEVICE

(71) Applicant: Beijing Xiaomi Mobile Software Co., Ltd., Beijing (CN)

(72) Inventor: Wei HONG, Beijing (CN)

(21) Appl. No.: 16/963,396

(22) PCT Filed: Jan. 30, 2018
(86) PCT No.: PCT/CN2018/074550

§ 371 Date: Jul. 20, 2020

(51) Int. Cl. H04W 12/08; H04W 60/00; H04B 7/185; H04W 8/24; H04W 74/08

(52) U.S. Cl. CPC H04W 12/08; H04W 60/00; H04W 74/0833; H04W 8/24; H04B 7/18506

(57) ABSTRACT

The present disclosure relates to a UAV service supporting method and device. The UAV service supporting method includes: receiving an attach request signaling sent by user equipment (UE) through a base station, the attach request signaling including UAV capability indication information, the UAV capability indication information being used to indicate whether the UE has a UAV capability; determining a UAV service authorization status of the UE based on the UAV capability indication information; and transmitting an initial context setup request signaling to the base station, the initial context setup request signaling including a UAV authorization signaling used for indicating the UAV service authorization state of the UE. By means of the disclosed technical solution, a core network device may indicate a UAV service authorization state of UE to a base station, thereby helping the base station to determine whether the UE is authorized to perform the UAV service, and when the UE is authorized to perform the UAV service, the UAV provides a UAV-related service.

### TECHNICAL FIELD

The disclosure relates to the technical field of wireless communication, and more particularly, to a method and device for supporting an unmanned aerial vehicle (UAV) service.

### BACKGROUND

An unmanned aerial vehicle, referred to as a UAV for short, has found applications for several specific scenarios to accomplish tasks such as aerial photography, unmanned explorations and investigations, measurements, surveying and mapping, road surveys, city planning, ecological environment monitoring and protection, scientific investigations, petroleum explorations, aerial remote sensing, a frontier defense and patrol, forest fire prevention, disaster assessment and so on.

In order to make the UAV be more widely used, in a discussion about a program for “enhanced support for UAVs” of the 3rd Generation Partnership Project (3GPP), it was proposed to make more standardized provision of services meeting UAV's requirements to the UAV by a cellar network. In this case, a base station needs to determine whether user equipment (UE) accessing the base station has a UAV capability. However, no schemes exist in related technology regarding how the base station determines whether the UE is authorized for a UAV service. As a result, it is necessary to come up with a new scheme to solve the problem of how the base station determines whether the UE is authorized for the UAV service.

### SUMMARY

A method and device for supporting a UAV service are provided in the embodiments of the disclosure to overcome problems in related technologies. The method and device for supporting the UAV service enable a core network device to indicate a UAV service authorization state of UE to a base station, which enables the base station to determine whether the UE is authorized for the UAV service, and to provide a UAV with a UAV-related service when the UE is authorized for the UAV service.

A first aspect according to the embodiments of the disclosure provides a method for supporting a UAV service applied to a core network device, the method including:

an attach request signaling that is transmitted by UE through a base station is received, the attach request signaling including UAV capability indication information, the UAV capability indication information being used for indicating whether the UE has a UAV capability;

a UAV service authorization state of the UE is determined based on the UAV capability indication information; and

an initial context setup request signaling is transmitted to the base station, the initial context setup request signaling including a UAV authorization signaling used for indicating the UAV service authorization state of the UE.

In an embodiment of the disclosure, the method further includes:

in response to a change in the UAV service authorization state of the UE, a UE context modification request signaling is transmitted to the base station, the UE context modification request signaling including the UAV authorization signaling used for indicating the UAV service authorization state of the UE.

In an embodiment of the disclosure, the operation of determining the UAV service authorization state of the UE includes:

a message for obtaining the UAV service authorization state of the UE is transmitted to a Home Subscriber Server (HSS), the enquiry message including identification information of the UE; and

the UAV service authorization state of the UE returned by the HSS is received.

In an embodiment of the disclosure, the operation of transmitting the initial context setup request signaling to the base station includes:

in response to that the UAV service authorization state of the UE is “not authorized”, a type of the UAV authorization signaling is set as “not authorized”, and

the initial context setup request signaling is transmitted to the base station, the initial context setup request signaling including the UAV authorization signaling used for indicating that the UAV service authorization state of the UE is “not authorized”; and

in response to that the UAV service authorization state of the UE is “authorized”, the type of the UAV authorization signaling is set as “authorized”, and

the initial context setup request signaling is transmitted to the base station, the initial context setup request signaling including the UAV authorization signaling used for indicating that the UAV service authorization state of the UE is “authorized”.

A second aspect according to the embodiments of the disclosure provides a method for supporting a UAV service applied to UE, the method including:

a random access operation is performed based on a random access procedure; and

an attach request signaling is transmitted to a core network device through a base station after the base station is accessed successfully, the attach request signaling including UAV capability indication information used for indicating whether the UE has a UAV capability.

A third aspect according to the embodiments of the disclosure provides a method for supporting a UAV service applied to a base station, the method including:

an initial context setup request signaling is received from a core network device, the initial context setup request signaling including a UAV authorization signaling used for indicating a UAV service authorization state of UE;

in response to that the UAV service authorization state is “authorized”, a UAV association service is provided to the UE; and

in response to that the UAV service authorization state is “not authorized”, providing the UAV association service to the UE is refused.

In an embodiment of the disclosure, the method further includes:

a UE context modification request signaling is received from the core network device, the UE context modification request signaling including the UAV authorization signaling used for indicating the UAV service authorization state of the UE;

a changed UAV service authorization state of the UE is determined based on the UAV authorization signaling in the UE context modification request signaling;

in response to that the changed UAV service authorization state is “not authorized”, a UAV association service is stopped being provided to the UE; and

in response to that the changed UAV service authorization state is “authorized”, the UAV association service is provided to the UE.

A fourth aspect according to the embodiments of the disclosure provides a device for supporting a UAV service applied to a core network device, the device including:

a first receiving module, configured to receive an attach request signaling that is transmitted by UE through a base station, the attach request signaling including UAV capability indication information, the UAV capability indication information being used for indicating whether the UE has a UAV capability;

a first determining module, configured to determine a UAV service authorization state of the UE based on the UAV capability indication information; and

a first transmitting module, configured to transmit an initial context setup request signaling to the base station, the initial context setup request signaling including a UAV authorization signaling used for indicating the UAV service authorization state of the UE.

In an embodiment of the disclosure, the device further includes:

a second transmitting module, configured to, in response to a change in the UAV service authorization state of the UE, transmit a UE context modification request signaling to the base station, the UE context modification request signaling including the UAV authorization signaling used for indicating the UAV service authorization state of the UE.

In an embodiment of the disclosure, the first determining module includes:

a first transmitting sub-module, configured to transmit a message for obtaining the UAV service authorization state of the UE to a Home Subscriber Server (HSS), the enquiry message including identification information of the UE; and

a first receiving sub-module, configured to receive the UAV service authorization state of the UE returned by the HSS.

In an embodiment of the disclosure, the first transmitting module includes:

a first setting sub-module, configured to, in response to that the UAV service authorization state of the UE is “not authorized”, set a type of the UAV authorization signaling as “not authorized”;

a second transmitting sub-module, configured to transmit the initial context setup request signaling to the base station, the initial context setup request signaling including the UAV authorization signaling used for indicating that the UAV service authorization state of the UE is “not authorized”;

a second setting sub-module, configured to, in response to that the UAV service authorization state of the UE is “authorized”, set the type of the UAV authorization signaling as “authorized”; and

a third transmitting sub-module, configured to transmit the initial context setup request signaling to the base station, the initial context setup request signaling including the UAV authorization signaling used for indicating that the UAV service authorization state of the UE is “authorized”.

A fifth aspect according to the embodiments of the disclosure provides a device for supporting a UAV service applied to UE, the device including:

an accessing module, configured to perform a random access operation based on a random access procedure; and

a third transmitting module, configured to transmit an attach request signaling to a core network device through a base station after the base station is accessed successfully, the attach request signaling including UAV capability indication information used for indicating whether the UE has a UAV capability.

A sixth aspect according to the embodiments of the disclosure provides a device for supporting a UAV service applied to a base station, the device including:

a second receiving module, configured to receive an initial context setup request signaling from a core network device, the initial context setup request signaling including a UAV authorization signaling used for indicating a UAV service authorization state of UE;

a first serving module, configured to, in response to that the UAV service authorization state is “authorized”, provide a UAV association service to the UE; and

a second serving module, configured to, in response to that the UAV service authorization state is “not authorized”, refuse to provide the UAV association service to the UE.

In an embodiment of the disclosure, the method further includes:

a third receiving module, configured to receive a UE context modification request signaling from the core network device, the UE context modification request signaling including the UAV authorization signaling used for indicating the UAV service authorization state of the UE;

a second determining module, configured to determine a changed UAV service authorization state of the UE based on the UAV authorization signaling in the UE context modification request signaling;

a third serving module, configured to, in response to that the changed UAV service authorization state is “not authorized”, stop providing a UAV association service to the UE; and

a fourth serving module, configured to, in response to that the changed UAV service authorization state is “authorized”, provide the UAV association service to the UE.

A seventh aspect according to the embodiments of the disclosure provides a core network device that includes:

a processor;

a memory configured to store instructions executable by the processor,

wherein the processor is configured to:

receive an attach request signaling that is transmitted by UE through a base station, the attach request signaling including UAV capability indication information, the UAV capability indication information being used for indicating whether the UE has a UAV capability;

determine a UAV service authorization state of the UE based on the UAV capability indication information; and

transmit an initial context setup request signaling to the base station, the initial context setup request signaling including a UAV authorization signaling used for indicating the UAV service authorization state of the UE.

An eighth aspect according to the embodiments of the disclosure provides UE that includes:

a processor;

a memory configured to store instructions executable by the processor,

wherein the processor is configured to:

perform a random access operation based on a random access procedure; and

transmit an attach request signaling to a core network device through a base station after accessing the base station successfully, the attach request signaling including UAV capability indication information used for indicating whether the UE has a UAV capability.

A ninth aspect according to the embodiments of the disclosure provides a base station that includes:

a processor;

a memory configured to store instructions executable by the processor,

wherein the processor is configured to:

receive an initial context setup request signaling from a core network device, the initial context setup request signaling including a UAV authorization signaling used for indicating a UAV service authorization state of UE;

in response to that the UAV service authorization state is “authorized”, provide a UAV association service to the UE; and

in response to that the UAV service authorization state is “not authorized”, refuse to provide the UAV association service to the UE.

A tenth aspect according to the embodiments of the disclosure provides a non-transitory computer-readable storage medium having stored thereon computer instructions that, when executed by a processor, implement following operations:

an attach request signaling that is transmitted by UE through a base station is received, the attach request signaling including UAV capability indication information, the UAV capability indication information being used for indicating whether the UE has a UAV capability;

a UAV service authorization state of the UE is determined based on the UAV capability indication information; and

an initial context setup request signaling is transmitted to the base station, the initial context setup request signaling including a UAV authorization signaling used for indicating the UAV service authorization state of the UE.

An eleventh aspect according to the embodiments of the disclosure provides a non-transitory computer-readable storage medium having stored thereon computer instructions that, when executed by a processor, implement following operations:

a random access operation is performed based on a random access procedure; and

an attach request signaling is transmitted to a core network device through a base station after the base station is accessed successfully, the attach request signaling including UAV capability indication information used for indicating whether the UE has a UAV capability.

A twelfth aspect according to the embodiments of the disclosure provides a non-transitory computer-readable storage medium having stored thereon computer instructions that, when executed by a processor, implement following operations:

an initial context setup request signaling is received from a core network device, the initial context setup request signaling including a UAV authorization signaling used for indicating a UAV service authorization state of UE;

in response to that the UAV service authorization state is “authorized”, a UAV association service is provided to the UE; and

in response to that the UAV service authorization state is “not authorized”, providing the UAV association service to the UE is refused.

The technical solutions provided in the embodiments of the disclosure may have beneficial effects as follows:

The core network device may determine the UAV service authorization state of the UE when receiving the attach request signaling including the UAV capability indication information from the UE, and indicate the UAV service authorization state of the UE to the base station through the initial context setup request signaling, which enables the base station to automatically provide the UAV association service to the UE when the UAV service authorization state of the UE is “authorized”. For example, the UE, which is authorized for the UAV service, may be allowed to take off and fly to a certain altitude or an exclusive resource is allocated to the UE that is authorized for the UAV service, so that the UAV is provided with a service meeting the UAV's requirements.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1A is a flowchart of a method for supporting a UAV service according to an exemplary embodiment of the disclosure.

FIG. 1B is a schematic diagram showing a scenario for a method for supporting a UAV service according to an exemplary embodiment of the disclosure.

FIG. 2 is a first flowchart of interaction between communication entities in a method for supporting a UAV service according to an exemplary embodiment of the disclosure.

FIG. 3 is a second flowchart of interaction between communication entities in yet another method for supporting a UAV service according to an exemplary embodiment of the disclosure.

FIG. 4 is a flowchart of a method for supporting a UAV service according to an exemplary embodiment of the disclosure.

FIG. 5 is a flowchart of a method for supporting a UAV service according to an exemplary embodiment of the disclosure.

FIG. 6 is a flowchart of yet another method for supporting a UAV service according to an exemplary embodiment of the disclosure.

FIG. 7 is a block diagram of a device for supporting a UAV service according to an exemplary embodiment of the disclosure.

FIG. 8 is a block diagram of another device for supporting a UAV service according to an exemplary embodiment of the disclosure.

FIG. 9 is a block diagram of a device for supporting a UAV service according to an exemplary embodiment of the disclosure.

FIG. 10 is a block diagram of a device for supporting a UAV service according to an exemplary embodiment of the disclosure.

FIG. 11 is a block diagram of another device for supporting a UAV service according to an exemplary embodiment of the disclosure.

FIG. 12 is a block diagram of a device for supporting a UAV service according to an exemplary embodiment of the disclosure.

FIG. 13 is a block diagram of a device for supporting a UAV service according to an exemplary embodiment of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

In the present disclosure, the UAV is a cellular network UAV that accesses a cellular network.

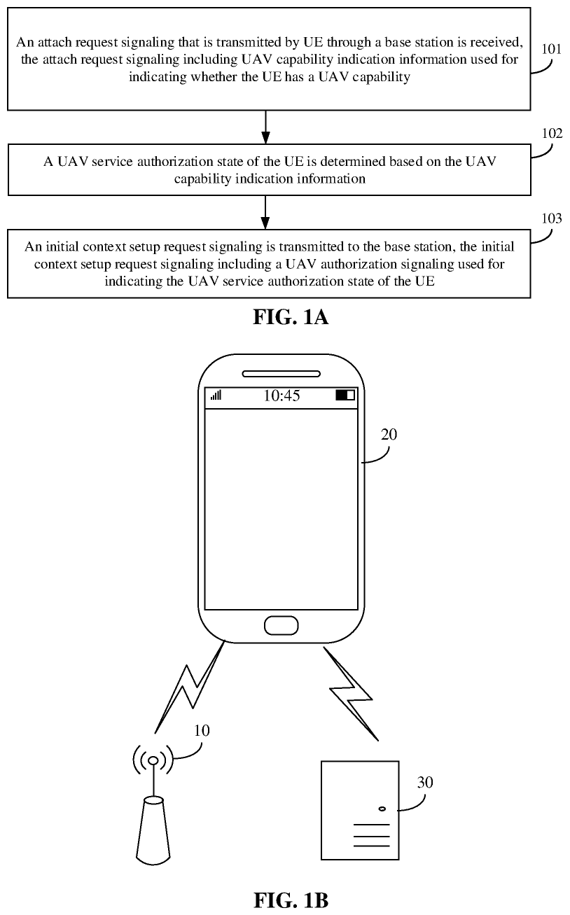

FIG. 1A is a flowchart of a method for supporting a UAV service according to an exemplary embodiment of the disclosure, and FIG. 1B is a schematic diagram showing a scenario for a method for supporting a UAV service according to an exemplary embodiment of the disclosure. The method for supporting the UAV service may be applied to a core network device. As illustrated in FIG. 1A, the method for supporting the UAV service includes following operations 101 to 103.

In operation 101, an attach request signaling that is transmitted by UE through a base station is received, the attach request signaling including UAV capability indication information used for indicating whether the UE has a UAV capability.

In an embodiment, after the UE accesses the base station through a random access procedure, that is, after the UE sets up a Radio Resource Control (RRC) connection, the UE may transmit an RRC connection setup complete message to the base station and include the attach request signaling of a Non-Access Stratum (NAS) in the message. The UE may include the UAV capability indication information, which is used for indicating whether the UE has the UAV capability, in the attach request signaling. Herein, the UAV capability indication information may be added in a UE network capability information element of the attach request signaling. After receiving the RRC connection setup complete message, the base station may transmit an initial UE message signaling including the attach request signaling to the core network device, so that the core network device may receive the attach request signaling.

In an embodiment, the UE may provide to the core network device an indication whether the UE itself has the UAV capability based on a value of the UAV capability indication information. For example, if the value of the UAV capability indication information is “true”, the core network device may determine that the UE has the UAV capability; if the value of the UAV capability indication information is “false”, the core network device may determine the UE has the UAV capability.

In an embodiment, it may be understood that the UAV capability includes some functions of the UAV such as a capability of flying to a certain altitude and a capability of moving fast.

In operation 102, a UAV service authorization state of the UE is determined based on the UAV capability indication information.

In an embodiment, the core network device may further check the UAV service authorization state of the UE when determining based on the UAV capability indication information that the UE has the UAV capability. In an embodiment, the core network device may transmit an enquiry message, which includes identification information of the UE and is used for obtaining the UAV service authorization state of the UE, to a Home Subscriber Server (HSS), and then receives the UAV service authorization state of the UE returned by the HSS.

In an embodiment, the UAV service authorization state may be understood as a state indicating whether the UE may use a UAV association service. If the UAV service authorization state is “authorized”, the base station may provide the UAV association service to the UE; if the UAV service authorization state is “not authorized”, the base station refuses to provide the UAV association service to the UE. Herein, the UAV association service may be understood as an exclusive service that the base station may provide to the UAV, for example, the UE that is authorized for the UAV service is allowed to take off and fly to a certain altitude, that is to say, the UE may still be provided with a cellular network service when the UE reaches an altitude (such as 500 meters); or a service of an exclusive resource is provided to the UE that is authorized for the UAV service.

In operation 103, an initial context setup request signaling is transmitted to the base station, the initial context setup request signaling including a UAV authorization signaling used for indicating the UAV service authorization state of the UE.

In an embodiment, in response to that the UAV service authorization state of the UE is “not authorized”, a type of the UAV authorization signaling is set as “not authorized”, and the initial context setup request signaling, which includes the UAV authorization signaling used for indicating that the UAV service authorization state of the UE is “not authorized”, is transmitted to the base station; in response to that the UAV service authorization state of the UE is “authorized”, the type of the UAV authorization signaling is set as “authorized”, and the initial context setup request signaling, which includes the UAV authorization signaling used for indicating that the UAV service authorization state of the UE is “authorized”, is transmitted to the base station.

In an embodiment, the UAV authorization signaling may indicate the UAV service authorization state of the UE to the base station by setting a value of a parameter “type and reference”. For example, in response to that the value of the parameter “type and reference” is “authorized”, it is indicated that the UAV service authorization state of the UE is “authorized”; in response to that the value of “type and reference” is “not authorized”, it is indicated that the UAV service authorization state of the UE is “not authorized”.

An exemplary scenario illustrated in FIG. 1B includes a base station 10, UE 20, a core network device 30 and so on. The UE 20 may transmit an attach request signaling to the core network device 30 through the base station 10. The attach request signaling includes UAV capability indication information used for indicating whether the UE 20 has a UAV capability. The core network device 30 determines a UAV service authorization state of the UE 20 based on the UAV capability indication information and transmits an initial context setup request signaling to the base station 10. The initial context setup request signaling includes a UAV authorization signaling used for indicating the UAV service authorization state of the UE 20, which enables the base station to automatically provide a UAV association service to the UE when the UAV service authorization state of the UE is “authorized”.

In the embodiment, by performing the above operations 101 to 103, the core network device may determine the UAV service authorization state of the UE when receiving the attach request signaling including the UAV capability indication information from the UE and indicate the UAV service authorization state of the UE to the base station through the initial context setup request signaling, which enables the base station to determine whether the UE is authorized for the UAV service, and to provide the UAV with the UAV-related service when the UE is authorized for the UAV service.

The subsequent embodiments may be referred to for a detailed implementation of support of the UAV service.

The technical solution provided by the embodiments of the disclosure is described below in detailed embodiments.

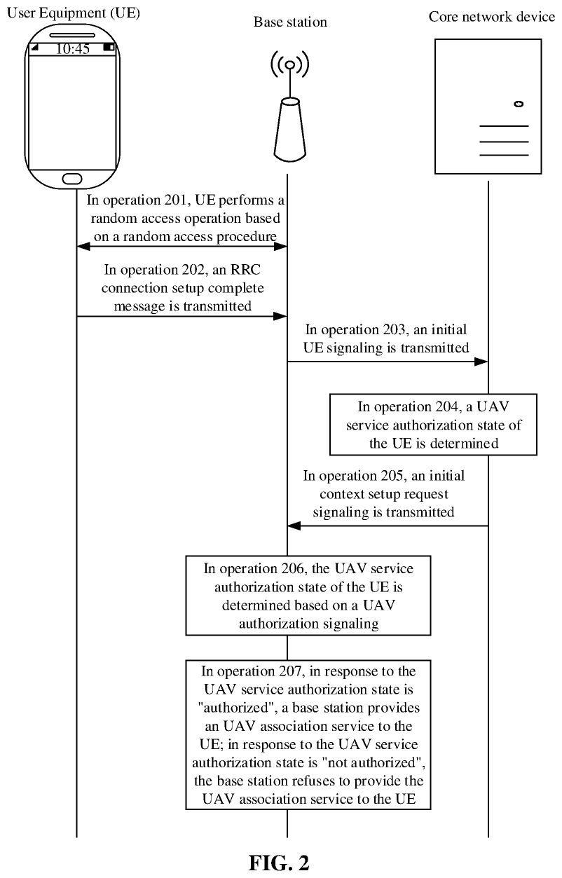

FIG. 2 is a first flowchart of interaction between communication entities in a method for supporting a UAV service according to an exemplary embodiment of the disclosure. In the embodiment, the above method provided by the embodiments of the disclosure is utilized to give an exemplary description based on an example that each of the communication entities interacts with each other to make the base station provide a UAV-related service to a UAV based on a UAV service authorization state of UE. As illustrated in FIG. 2, the method includes following operations 201 to 207.

In operation 201, the UE performs a random access operation based on a random access procedure.

In operation 202, after successfully accessing the base station, the UE transmits an RRC connection setup complete message including an attach request signaling of an NAS to a base station.

In an embodiment, the attach request signaling includes UAV capability indication information that may be added in a UE network capability information element of the attach request signaling.

In operation 203, the base station transmits an initial UE signaling including the attach request signaling to a core network device.

In operation 204, the core network device determines the UAV service authorization state of the UE based on the UAV capability indication information in the attach request signaling.

In an embodiment, the core network device may determine the UAV service authorization state of the UE through an HS S server.

In operation 205, the core network device transmits an initial context setup request signaling to the base station, the initial context setup request signaling including a UAV authorization signaling used for indicating the UAV service authorization state of the UE

The description of operations 102 to 103 in the embodiment illustrated in FIG. 1A may be referred to for the description of operations 204 and 205 in an embodiment, which will not be elaborated herein.

In operation 206, the base station determines the UAV service authorization state of the UE based on the UAV authorization signaling.

In operation 207, in response to the UAV service authorization state is “authorized”, the base station provides an UAV association service to the UE; in response to the UAV service authorization state is “not authorized”, the base station refuses to provide the UAV association service to the UE.

In an embodiment, in operations 206 to 207, in response to that a value of a parameter “type and reference” in the UAV authorization signaling is “authorized”, it is indicated that the UAV service authorization state of the UE is “authorized” and the base station may provide the UAV association service to the UE; in response to that the value of “type and reference” is “not authorized”, it is indicated that the UAV service authorization state of the UE is “not authorized” and the base station refuses to provide the UAV association service to the UE.

In the embodiment, signaling interaction among the UE, the base station and the core network device enables the core network device to indicate the UAV service authorization state of the UE to the base station, so that the base station may determine whether to provide the UAV association service to the UE, for example, the UE, which is authorized for the UAV service, is allowed to take off and fly to a certain altitude or an exclusive resource is allocated to the UE that is authorized for the UAV service, so that the UAV is provided with a service meeting the UAV's requirements.

FIG. 3 is a second flowchart of interaction between each communication entities in yet another method for supporting a UAV service according to an exemplary embodiment of the disclosure. In the embodiment the above method provided by the embodiments of the disclosure is utilized to give an exemplary description based on an example that each of the communication entities interacts with each other to make a core network device notify a base station timely in response to a change in the UAV service authorization state of UE, so that the base station may provide a UAV-related service to a UAV based on the UAV service authorization state of the UE. As illustrated in FIG. 3, the method includes following operations 301 to 303.

In operation 301, in response to the change in the UAV service authorization state of the UE, the core network device transmits a UE context modification request signaling to the base station, the UE context modification request signaling including a UAV authorization signaling used for indicating the UAV service authorization state of the UE.

In an embodiment, the UAV service authorization state of the UE may change. For example, in a normal situation the UAV service authorization state of the UE is “authorized” while it is likely that the UAV service authorization state of the UE is changed to “not authorized” when the UE runs out of credit or cannot access a cellular network. The core network device may transmit the UE context modification request signaling, which may include a UAV authorization signaling used for indicating the UAV service authorization state of the UE, to the base station. Herein, the UAV authorization signaling is used for indicating the UAV service authorization state of the UE.

In an embodiment, the UAV service authorization state of the UE may also change from “not authorized” to “authorized”. For example, when the UE ran out of credit, the UAV service authorization state of the UE was “not authorized”; while the UAV service authorization state of the UE is “authorized” after an overdue phone bill is paid.

In operation 302, the base station determines a changed UAV service authorization state of the UE based on the UAV authorization signaling in the UE context modification request signaling.

In operation 303, in response to that the changed UAV service authorization state is “not authorized”, the base station stops providing a UAV association service to the UE; and in response to that the changed UAV service authorization state is “authorized”, the base station provides the UAV association service to the UE.

In an embodiment, in operations 302 to 303, in response to that a value of a parameter “type and reference” in the UAV authorization signaling is “authorized”, it is indicated that the UAV service authorization state of the UE is “authorized” and the base station may provide the UAV association service to the UE; in response to that the value of “type and reference” is “not authorized”, it is indicated that the UAV service authorization state of the UE is “not authorized” and the base station refuses to provide the UAV association service to the UE.

In the embodiment, signaling interaction among the UE, the base station and the core network device enables the core network device to indicate the change in the UAV service authorization state of the UE to the base station timely, so that the base station may determine whether to provide the UAV association service to the UE, for example, the UE, which is authorized for the UAV service, is allowed to take off and fly to a certain altitude or an exclusive resource is allocated to the UE that is authorized for the UAV service, so that the UAV is provided with a service meeting the UAV's requirements.

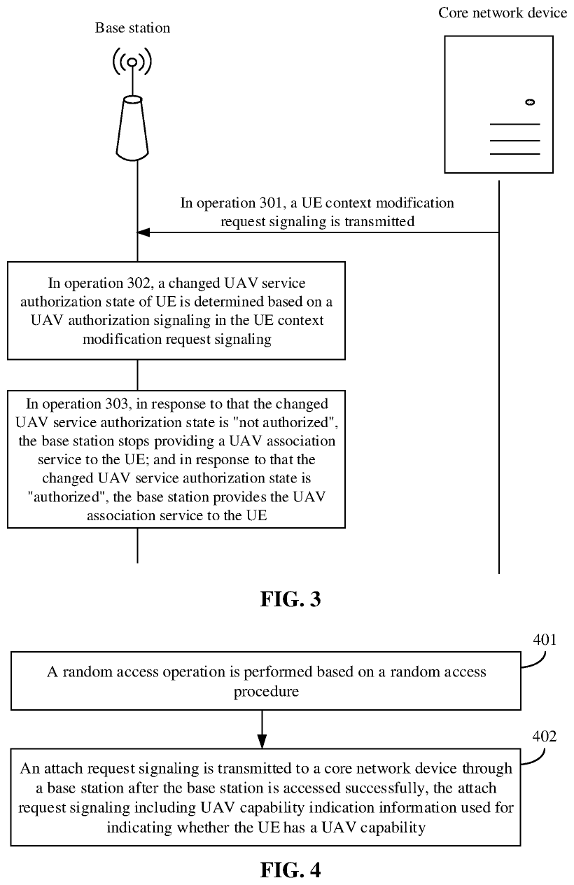

FIG. 4 is a flowchart of a method for supporting a UAV service according to an exemplary embodiment of the disclosure. The method for supporting the UAV service may be applied to UE. As illustrated in FIG. 4, the method for supporting the UAV service includes following operations 401 to 402.

In operation 401, a random access operation is performed based on a random access procedure.

In operation 402, an attach request signaling is transmitted to a core network device through a base station after the base station is accessed successfully, the attach request signaling including UAV capability indication information used for indicating whether the UE has a UAV capability.

In an embodiment, the attach request signaling may include the UAV capability indication information that may be added in a UE network capability information element of the attach request signaling.

In the embodiment, by performing the above operations 401 to 402, the UE may report its UAV capability indication information to a core network device through the attach request signaling, which enables the core network device to indicate a UAV service authorization state of the UE to the base station.

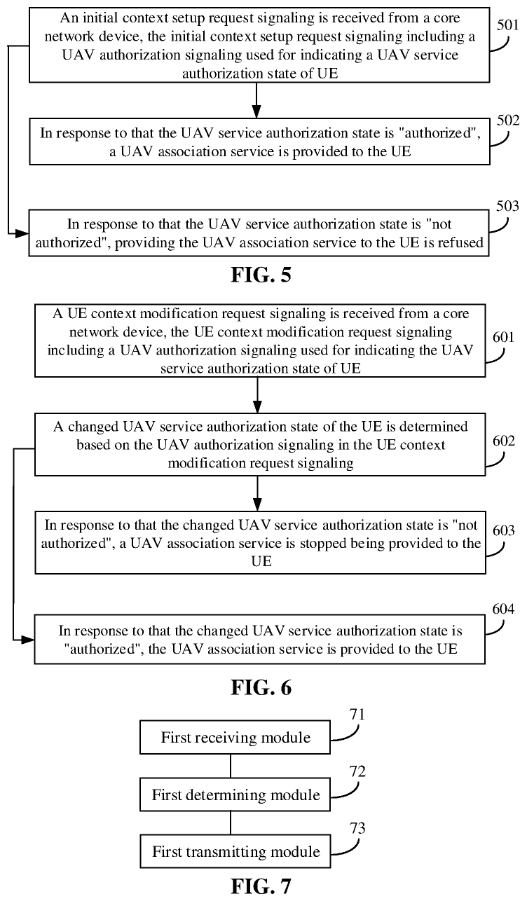

FIG. 5 is a flowchart of a method for supporting a UAV service according to an exemplary embodiment of the disclosure. The method for supporting the UAV service may be applied to a base station. As illustrated in FIG. 5, the method for supporting the UAV service includes following operations 501 to 503.

In operation 501, an initial context setup request signaling is received from a core network device, the initial context setup request signaling including a UAV authorization signaling used for indicating a UAV service authorization state of UE. Then operation 502 or 503 is to be performed.

In an embodiment, in response to that a value of a parameter “type and reference” in the UAV authorization signaling is “authorized”, it is indicated that the UAV service authorization state of the UE is “authorized”; in response to that the value of “type and reference” is “not authorized”, it is indicated that the UAV service authorization state of the UE is “not authorized”.

In operation 502, in response to that the UAV service authorization state is “authorized”, a UAV association service is provided to the UE.

In an embodiment, the UAV association service may be understood as an exclusive service that the base station may provide to a UAV, for example, the UE that is authorized for the UAV service is allowed to take off and fly to a certain altitude, that is to say, the UE is still provided with a cellular network service when the UE reaches the certain altitude (such as 500 meters), or the UE that is authorized for the UAV service is provided with a service of an exclusive resource.

In operation 503, in response to that the UAV service authorization state is “not authorized”, providing the UAV association service to the UE is refused.

In the embodiment, the base station can determine whether to provide the UAV association service to the UE, based on the UAV service authorization state of the UE, and thus provides the UE, which is authorized for the UAV association service, with a best cellular network service that meets requirements.

FIG. 6 is a flowchart of yet another method for supporting a UAV service according to an exemplary embodiment of the disclosure. In the embodiment the above method provided by the embodiments of the disclosure is utilized to give an exemplary description based on an example that in response to a change in a UAV service authorization state of UE, a base station determines whether to provide a UAV association service to the UE based on a changed UAV service authorization state. As illustrated in FIG. 6, the method includes following operations:

In operation 601, a UE context modification request signaling is received from a core network device, the UE context modification request signaling including the UAV authorization signaling used for indicating the UAV service authorization state of the UE.

In operation 602, the changed UAV service authorization state of the UE is determined based on the UAV authorization signaling in the UE context modification request signaling. Then operation 603 or 604 is to be performed.

In operation 603, in response to that the changed UAV service authorization state is “not authorized”, a UAV association service is stopped being provided to the UE.

In operation 604, in response to that the changed UAV service authorization state is “authorized”, the UAV association service is provided to the UE.

In the embodiment, in response to that the UAV service authorization state of the UE changes, the base station may determine whether to provide the UAV association service to the UE because of an indication of the core network device, for example, the UE, which is authorized for the UAV service, is allowed to take off and fly to a certain altitude, or an exclusive resource is allocated to the UE that is authorized for the UAV service, so that the UAV is provided with a service meeting the UAV's requirements.

FIG. 7 is a block diagram of a device for supporting a UAV service according to an exemplary embodiment of the disclosure. The device is applied to a core network device. As illustrated in FIG. 7, the device for supporting the UAV service includes:

a first receiving module 71, configured to receive an attach request signaling that is transmitted by UE through a base station, the attach request signaling including UAV capability indication information used for indicating whether the UE has a UAV capability;

a first determining module72, configured to determine a UAV service authorization state of the UE based on the UAV capability indication information; and

a first transmitting module 73, configured to transmit an initial context setup request signaling to the base station, the initial context setup request signaling including a UAV authorization signaling used for indicating the UAV service authorization state of the UE.

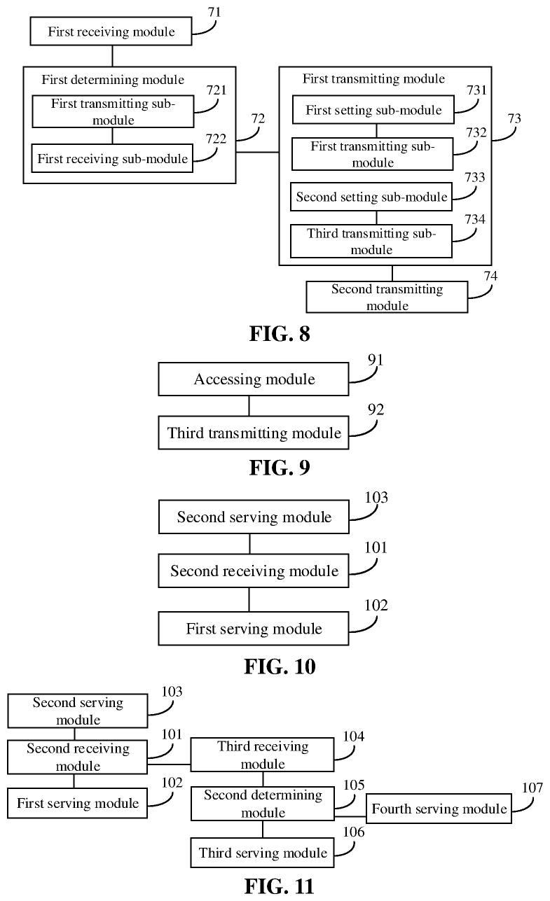

FIG. 8 is a block diagram of another device for supporting a UAV service according to an exemplary embodiment of the disclosure. As illustrated in FIG. 8, in an embodiment, based on the above embodiment illustrated in FIG. 7, the device further includes:

a second transmitting module 74, configured to, in response to a change in the UAV service authorization state of the UE, transmit a UE context modification request signaling to the base station, the UE context modification request signaling including the UAV authorization signaling used for indicating the UAV service authorization state of the UE.

In an embodiment, the first determining module 72 includes:

a first transmitting sub-module 721, configured to transmit a message for obtaining the UAV service authorization state of the UE to an HSS, the enquiry message including identification information of the UE; and

a first receiving sub-module 722, configured to receive the UAV service authorization state of the UE returned by the HSS.

In an embodiment, the first transmitting module 73 includes:

a first setting sub-module 731, configured to, in response to that the UAV service authorization state of the UE is “not authorized”, set a type of the UAV authorization signaling as “not authorized”;

a second transmitting sub-module 732, configured to transmit the initial context setup request signaling to the base station, the initial context setup request signaling including the UAV authorization signaling used for indicating that the UAV service authorization state of the UE is “not authorized”;

a second setting sub-module 733, configured to, in response to that the UAV service authorization state of the UE is “authorized”, set the type of the UAV authorization signaling as “authorized”; and

a third transmitting sub-module 734, configured to transmit the initial context setup request signaling to the base station, the initial context setup request signaling including the UAV authorization signaling used for indicating that the UAV service authorization state of the UE is “authorized”.

FIG. 9 is a block diagram of a device for supporting a UAV service according to an exemplary embodiment of the disclosure. The device is applied to UE. As illustrated in FIG. 9, the device for supporting the UAV service includes:

an accessing module 91, configured to perform a random access operation based on a random access procedure; and

a third transmitting module 92, configured to transmit an attach request signaling to a core network device through a base station after the base station is accessed successfully, the attach request signaling including UAV capability indication information used for indicating whether the UE has a UAV capability.

FIG. 10 is a block diagram of a device for supporting a UAV service according to an exemplary embodiment of the disclosure. The device is applied to a base station. As illustrated in FIG. 10, the device for supporting the UAV service includes:

a second receiving module 101, configured to receive an initial context setup request signaling from a core network device, the initial context setup request signaling including a UAV authorization signaling used for indicating a UAV service authorization state of UE;

a first serving module 102, configured to, in response to that the UAV service authorization state is “authorized”, provide a UAV association service to the UE; and

a second serving module 103, configured to, in response to that the UAV service authorization state is “not authorized”, refuse to provide the UAV association service to the UE.

FIG. 11 is a block diagram of another device for supporting a UAV service according to an exemplary embodiment of the disclosure. As illustrated in FIG. 11, in an embodiment, based on the above embodiment illustrated in FIG. 10, the device further includes:

a third receiving module 104, configured to receive a UE context modification request signaling from the core network device, the UE context modification request signaling including the UAV authorization signaling used for indicating the UAV service authorization state of the UE;

a second determining module 105, configured to determine a changed UAV service authorization state of the UE based on the UAV authorization signaling in the UE context modification request signaling;

a third serving module 106, configured to, in response to that the changed UAV service authorization state is “not authorized”, stop providing a UAV association service to the UE; and

a fourth serving module 107, configured to, in response to that the changed UAV service authorization state is “authorized”, provide the UAV association service to the UE.

With respect to the device in the above embodiments, the specific manners in which the modules perform the operations have been described in detail in the method embodiments, which will not be elaborated herein.

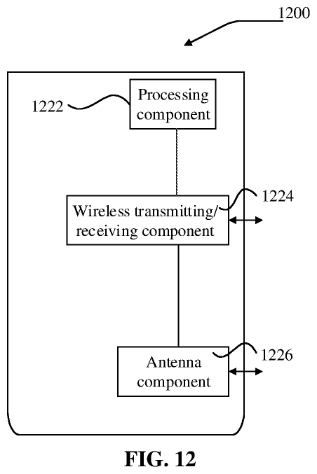

FIG. 12 is a block diagram of a device for supporting the UAV service according to an exemplary embodiment of the disclosure. The device 1200 may be provided as a base station or a core network device. As illustrated in FIG. 12, the device 1200 includes a processing component 1222, a wireless transmitting/receiving component 1224, an antenna component 1226 and a signal-processing section specific to a wireless interface. The processing component 1222 may further include one or more processors.

When the device 1200 is a core network device, one of the processors in the processing component 1222 may be configured to perform the method for supporting the UAV service described in the above first aspect.

When the device 1200 is a base station, one of the processors in the processing component 1222 may be configured to perform the method for supporting the UAV service described in the above third aspect.

In an exemplary embodiment, there is also provided a non-transitory computer-readable storage medium including instructions. The above instructions may be performed by the processing component 1222 of the device 1200 to accomplish the method described in the above first aspect or the method described in the above third aspect. For example, the non-transitory computer-readable storage medium may be a Read-Only Memory (ROM), a Random Access Memory (RAM), a Compact Disc Read-Only Memory (CD-ROM), a magnetic tape, a floppy disc, an optical data storage device or the like.

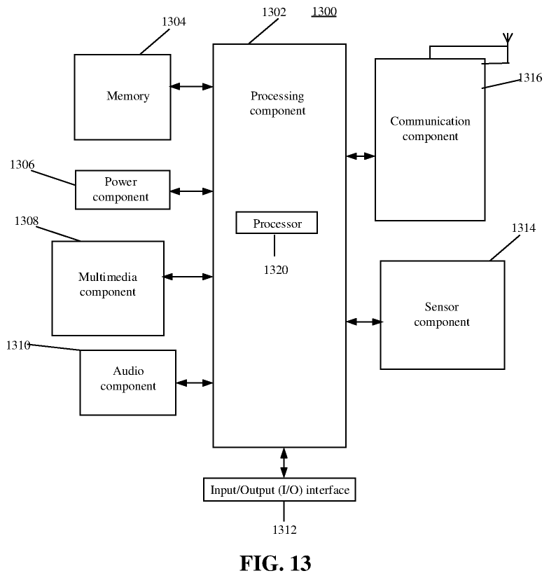

FIG. 13 is a block diagram of a device for establishing a fast connection between devices of the Internet of Things according to an exemplary embodiment of the disclosure. For example, the device 1300 may be a source device and a target device such as a smart phone.

The device 1300 may include one or more of the following components: a processing component 1302, a memory 1304, a power component 1306, a multimedia component 1308, an audio component 1310, an Input/Output (I/O) interface 1313, a sensor component 1314, and a communication component 1316.

The processing component 1302 typically controls overall operations of the device 1300, such as the operations associated with display, telephone calls, data communications, camera operations, and recording operations. The processing component 1302 may include one or more processors 1320 to execute instructions to perform all or part of the operations in the abovementioned method. Moreover, the processing component 1302 may include one or more modules which facilitate interaction between the processing component 1302 and the other components. For instance, the processing component 1302 may include a multimedia module to facilitate interaction between the multimedia component 1308 and the processing component 1302.

The memory 1304 is configured to store various types of data to support the operation of the device 1300. Examples of such data include instructions for any application program or method operated on the device 1300, messages, pictures, etc. The memory 1304 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), an ROM, a magnetic memory, a flash memory, a magnetic or optical disk.

The power component 1306 provides power for various components of the device 1300. The power component 1306 may include a power management system, one or more power supplies, and other components associated with generation, management and distribution of power for the device 1300.

The multimedia component 1308 includes a screen providing an output interface between the device 1300 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 1308 includes a front camera and/or a rear camera. The front camera and/or the rear camera may receive external multimedia data when the device 1300 is in an operation mode, such as a photographing mode or a video mode. Each of the front camera and the rear camera may be a fixed optical lens system or have focusing and optical zooming capability.

The audio component 1310 is configured to output and/or input audio signals. For example, the audio component 1310 includes a Microphone (MIC), and the MIC is configured to receive an external audio signal when the device 1300 is in an operation mode, such as a call mode, a recording mode and a voice recognition mode. The received audio signal may further be stored in the memory 1304 or sent through the communication component 1316. In some embodiments, the audio component 1310 further includes a speaker configured to output the audio signal.

The I/O interface 1312 provides an interface between the processing component 1302 and a peripheral interface module, and the peripheral interface module may be a keyboard, a click wheel, a button and the like. The button may include, but not limited to: a home button, a volume button, a starting button and a locking button.

The sensor component 1314 includes one or more sensors configured to provide status assessment in various aspects for the device 1300. For instance, the sensor component 1314 may detect an on/off status of the device 1300 and relative positioning of components, such as a display and small keyboard of the device 1300, and the sensor component 1314 may further detect a change in a position of the device 1300 or a component of the device 1300, presence or absence of contact between the user and the device 1300, orientation or acceleration/deceleration of the device 1300 and a change in temperature of the device 1300. The sensor component 1314 may include a proximity sensor configured to detect presence of an object nearby without any physical contact. The sensor component 1314 may also include a light sensor, such as a Complementary Metal Oxide Semiconductor (CMOS) or Charge Coupled Device (CCD) image sensor, configured for use in an imaging application. In some embodiments, the sensor component 1314 may also include an acceleration sensor, a gyroscope sensor, a magnetic sensor, a pressure sensor or a temperature sensor.

The communication component 1316 is configured to facilitate wired or wireless communication between the device 1300 and another device. The device 1300 may access a communication-standard-based wireless network, such as a Wireless Fidelity (Wi-Fi) network, a 2nd-Generation (2G) or 3rd-Generation (3G) network or a combination thereof. In an exemplary embodiment, the communication component 1316 receives a broadcast signal or broadcast associated information from an external broadcast management system through a broadcast channel. In an exemplary embodiment, the communication component 1316 further includes a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the device 1300 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to perform the above described method for establishing the fast connection between the devices of the Internet of Things

In an exemplary embodiment, there is also provided a non-transitory computer-readable storage medium including instructions, such as the memory 1304 including instructions, and the instructions may be executed by the processor 1320 of the device 1300 to implement the method for supporting the UAV service in the above second aspect. For example, the non-transitory computer-readable storage medium may be an ROM, a RAM, a CD-ROM, a magnetic tape, a floppy disc, an optical data storage device or the like.

Other implementations of the present disclosure will be apparent to those skilled in the art from consideration of the specification and practice of the present disclosure. The disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for supporting an unmanned aerial vehicle (UAV) service, applied to a core network device, the method comprising:
receiving an attach request signaling that is transmitted by user equipment (UE) through a base station, the attach request signaling comprising UAV capability indication information, the UAV capability indication information being configured to indicate whether the UE has a UAV capability;
determining a UAV service authorization state of the UE based on the UAV capability indication information; and
transmitting an initial context setup request signaling to the base station, the initial context setup request signaling comprising a UAV authorization signaling configured to indicate the UAV service authorization state of the UE.

2. The method of claim 1, further comprising:
in response to a change in the UAV service authorization state of the UE, transmitting a UE context modification request signaling to the base station, the UE context modification request signaling comprising the UAV authorization signaling configured to indicate the UAV service authorization state of the UE.

3. The method of claim 1, wherein determining the UAV service authorization state of the UE comprises:
transmitting an enquiry message for obtaining the UAV service authorization state of the UE to a Home Subscriber Server (HSS), the enquiry message comprising identification information of the UE; and
receiving the UAV service authorization state of the UE returned by the HSS.

4. The method of claim 1, wherein transmitting the initial context setup request signaling to the base station comprises:
in response to that the UAV service authorization state of the UE is an unauthorized state, setting a type of the UAV authorization signaling as an unauthorized type, and
transmitting the initial context setup request signaling to the base station, the initial context setup request signaling comprising the UAV authorization signaling configured to indicate that the UAV service authorization state of the UE is the unauthorized state; and
in response to that the UAV service authorization state of the UE is an authorized state, setting the type of the UAV authorization signaling as an authorized type, and
transmitting the initial context setup request signaling to the base station, the initial context setup request signaling comprising the UAV authorization signaling configured to indicate that the UAV service authorization state of the UE is the authorized state.

5. A method for supporting an unmanned aerial vehicle (UAV) service, applied to user equipment (UE), the method comprising:
performing a random access operation based on a random access procedure; and
transmitting an attach request signaling to a core network device through a base station after accessing the base station successfully, the attach request signaling comprising UAV capability indication information configured to indicate whether the UE has a UAV capability.

6. A method for supporting an unmanned aerial vehicle (UAV) service, applied to a base station, the method comprising:
receiving an initial context setup request signaling from a core network device, the initial context setup request signaling comprising a UAV authorization signaling configured to indicate a UAV service authorization state of user equipment (UE);
in response to that the UAV service authorization state is an authorized state, providing a UAV association service to the UE; and
in response to that the UAV service authorization state is an unauthorized state, refusing to provide the UAV association service to the UE.

7. The method of claim 6, further comprising:
receiving a UE context modification request signaling from the core network device, the UE context modification request signaling comprising the UAV authorization signaling configured to indicate the UAV service authorization state of the UE;
determining a changed UAV service authorization state of the UE based on the UAV authorization signaling in the UE context modification request signaling;
in response to that the changed UAV service authorization state is the unauthorized state, stopping providing a UAV association service to the UE; and
in response to that the changed UAV service authorization state is the authorized state, providing the UAV association service to the UE.

8.-14. (canceled)

15. A core network device, comprising:
a processor; and
a memory configured to store instructions executable by the processor,
wherein the processor is configured to perform the method of claim 1.

16. User equipment (UE), comprising:
a processor; and
a memory configured to store instructions executable by the processor,
wherein the processor is configured to perform the method of claim 5.

17. A base station, comprising:
a processor; and
a memory configured to store instructions executable by the processor,
wherein the processor is configured to perform the method of claim 6.

18. A non-transitory computer-readable storage medium having stored thereon computer instructions that, when executed by a processor, implement the method of claim 1.

19. A non-transitory computer-readable storage medium having stored thereon computer instructions that, when executed by a processor, implement the method of claim 5.

20. A non-transitory computer-readable storage medium having stored thereon computer instructions that, when executed by a processor, implement the method of claim 6.
